(19) United States
(12) Patent Application Publication
(10) Pub. No.: US 2026/0251877 A1
(43) Pub. Date: Aug. 27, 2026

(54) SPLICE TRAYS WITH A BUFFER TUBE LOCK

(71) Applicant: Panduit Corp., Tinley Park, IL (US)

(72) Inventors: Kevin M. Zumbek, Palos Heights, IL (US); Olga Khavarivska, Naperville, IL (US)

(73) Assignee: Panduit Corp., Tinley Park, IL (US)

(21) Appl. No.: 19/065,090

(22) Filed: Feb. 27, 2025

(51) Int. Cl. G02B 6/44

(52) U.S. Cl. CPC G02B 6/4454

(57) ABSTRACT

A fiber optic splice tray with a splice support system has a splice tray and a splice support system. The splice support system includes a buffer tube lock with a tube holder attached to the tray base and wherein the tube lock further includes a latch attached via a hinge to the tube holder.

### FIELD OF INVENTION

The present invention relates generally to splice trays and more specifically to splice trays with a buffer tube lock.

### BACKGROUND

The North American broadband fiber to the home (FTTH) market is experiencing labor shortages as telecommunications companies (telecoms) and regional utility cooperatives (Coops) push to connect all homes and businesses with high-speed internet. One critical and laborious process within a new broadband network buildout is fiber splicing. Fiber splicing requires specially trained technicians who are particularly in short supply. Any labor savings related to splicing is especially valuable to telecoms and Coops. Much of the prior art uses a metallic pedestal which includes a splice tray. The fiber attaches to the tray by a traditional method in industry wherein the termination of the fiber buffer tubes are first individually wrapped in small pieces of adhesive felt tape and then secured to the tray with multiple cable ties. This method provides strain relief for the buffer tube while preventing crushing or kinking of the tube, which can result in damage to the internal fibers. However, the technician will spend considerable time attaching the buffer tubes. What is needed is a method of attachment of multiple buffer tubes to a general purpose splice tray that provides strain relief, prevents damage to fibers and tubes, and can be deployed more quickly than traditional methods.

### SUMMARY

A fiber optic splice tray with a splice support system has a splice tray and a splice support system. The splice support system includes a buffer tube lock with a tube holder attached to the tray base and wherein the tube lock further includes a latch attached via a hinge to the tube holder.

### BRIEF DESCRIPTION OF THE DRAWINGS

FIG. 1 is an isometric view of splice support system 10.

FIG. 2 is an isometric view of splice support system 10 with cover 16 removed for clarity.

FIG. 3 is an isometric view of splice support system 10 with cover 16 removed for clarity and one of the tube locks 18 shown in the opened position.

FIG. 4 is a bottom view of buffer tube lock 18 shown with one buffer tube 12 installed.

FIG. 5 is an isometric view of tube holder 126 which is supporting buffer 12 which contains a number of fibers 20 (one shown).

FIG. 6 is a top view of FIG. 5.

### DESCRIPTION OF INVENTION

The present invention is a fiber optic splice tray with a buffer tube lock which can be deployed in pedestals, dome closures, splice cabinets, or within any device suitable for supporting splices of fiber optic cable.

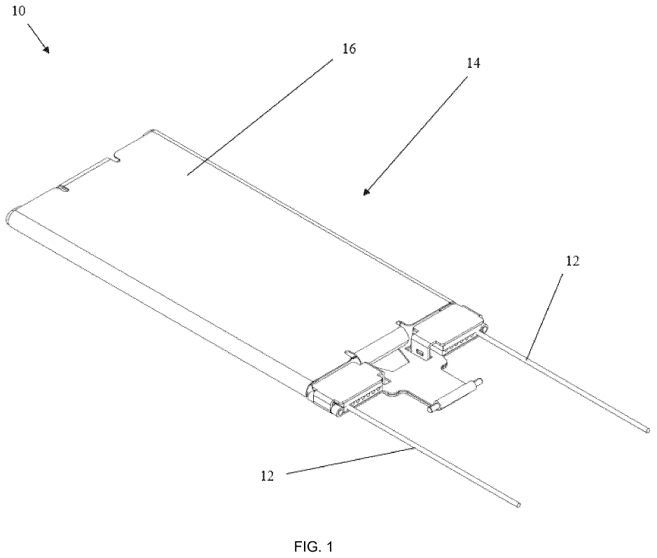

FIG. 1 is an isometric view of splice support system 10 which includes fiber optic buffer tubes 12, splice tray 14 and cover 16. Buffer tubes 12 protrude from a standard, loose tube fiber optic cable assembly (not shown) before entering splice tray 14.

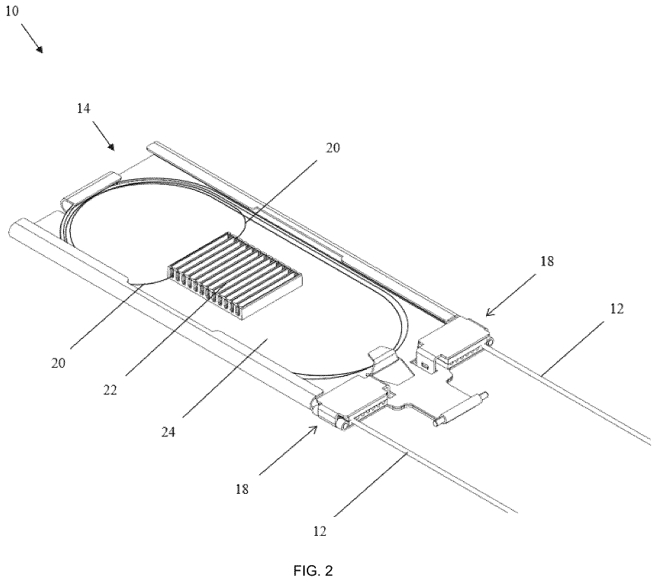

FIG. 2 is an isometric view of splice support system 10 with cover 16 removed for clarity. Buffer tubes 12 enter splice tray 14 through tube locks 18 and are trimmed at a short distance beyond tube locks 18. Each buffer tube 12 contains a number of loose fibers 20 (one per each is shown) that protrudes beyond the trimmed end to route inside splice tray 14. Fibers 20 are spliced together and held inside a number of splice holders 22 (one shown) which is attached to tray base 24.

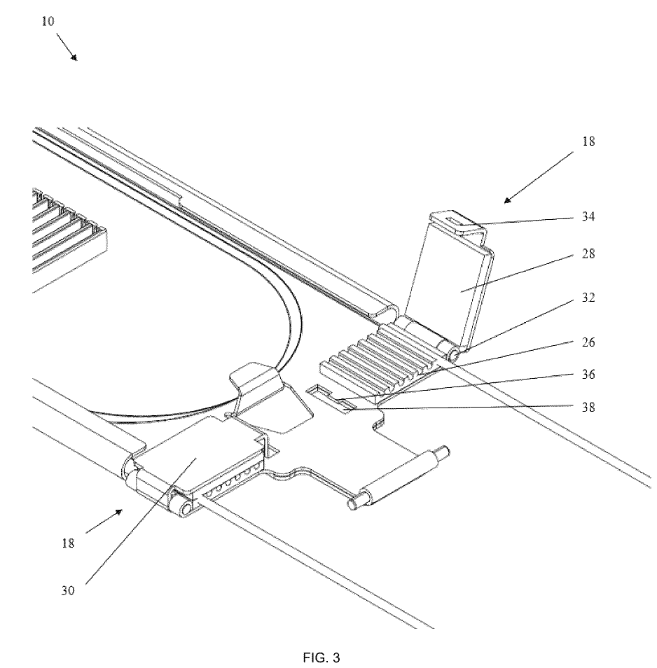

FIG. 3 is an isometric view of splice support system 10 with cover 16 removed for clarity and one of the tube locks 18 shown in the opened position. Tube locks 18 are a mirror of each other and are each comprised of tube holder 26, pad 28, latch 30, and hinge pin 32. Tube holder 26 is permanently attached to tray base 24 with adhesive. Pad 28 is permanently attached to latch 30 with adhesive. Latch 30 is connected to tray base 24 through hinge pin 32 which allows it to rotate 180-degrees. Latch 30 includes loop 34 which deflects to snap on to tab 36 when inserting into tray base 24 through hole 38 which secures it in the closed position.

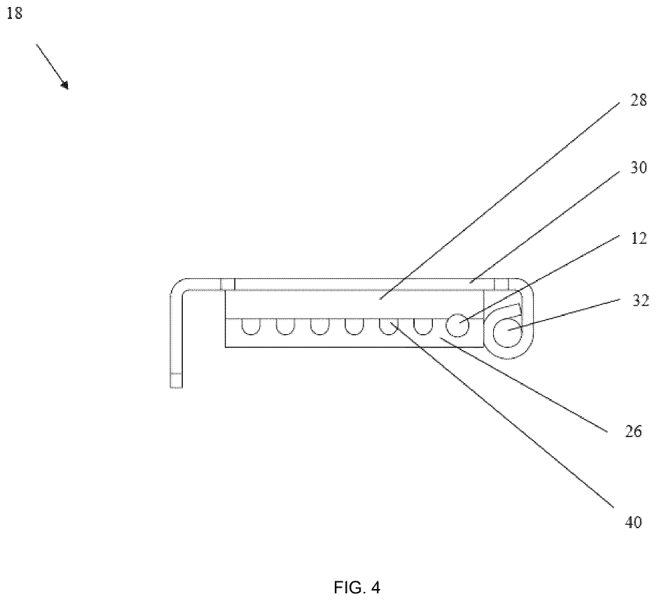

FIG. 4 is a bottom view of buffer tube lock 18 shown with one buffer tube 12 installed. Tube holder 26 includes a number of slots 40 which each can support buffer tube 12. Tube holder 26 is comprised of a soft, elastomeric material, and slots 40 are a narrower width than buffer tubes 12 in order to create a high-friction interference fit which provides a degree of support and strain relief for the buffer tubes while the field technician is handling the splice tray 14 with buffer tube lock 18 in the opened position. Pad 28 may be comprised of a soft elastomeric material or a soft foam material such that when the buffer tube lock 18 is closed, it compresses buffer tubes 12 into slots 40 which increases the friction and provides a higher degree of support and strain relief. To populate the splice tray, the field technician only needs to press the trimmed buffer tubes into slots 40 and then close and lock latch 30 which reduces total time of installation compared to traditional methods.

Buffer tube 12 may be replaced by a segment of fiber transport tubing of similar diameter for use with fiberoptic ribbon cable that does not contain suitable buffer tubes. The field technician may insert fiber ribbons through the end of the segment of fiber transport tubing and attach the tubing to buffer tube lock 18 in the same manner as buffer tube 12.

Splice tray 14 may include any number of buffer tube locks 18 and may include buffer tube locks 18 on both ends of the tray, allowing fiber ingress from both sides.

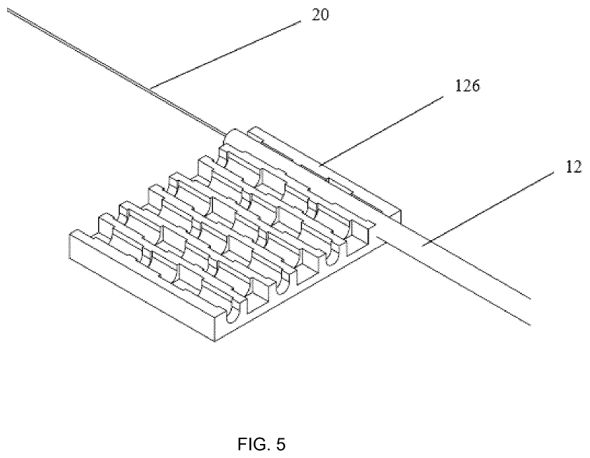

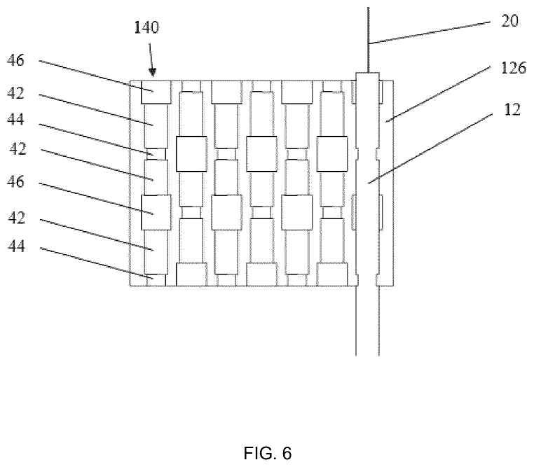

FIG. 5 is an isometric view of tube holder 126 which is supporting buffer 12 which contains a number of fibers 20 (one shown). FIG. 6 is a top view of FIG. 5. Tube holder 126 is an alternate form of tube holder 26 and permits various diameters of buffer tubes 12 to be attached when multiple types of fiber optic cables must be spliced in the same tray 14. Tube holder 126 includes a number of slots 140 which are each comprised of a number of large ‘U’-shaped pockets 42, a number of small ‘U’-shaped pockets 44, and a number of rectangular pockets 46 which are all inline. When buffer tube 12 has a small diameter that is typical of some fiber optical cables, the width of small ‘U’-shaped pockets 44 is smaller than the diameter buffer tube 12 while the width of large ‘U’-shaped pockets 42 may be larger than the diameter of buffer tube 12. This creates a high-friction interference fit between the buffer tubes 12 and small ‘U’-shaped pockets 44 which provides a degree of support and strain relief. When buffer tube 12 has a large diameter that is typical of some fiber optical cables, the widths of both large ‘U’-shaped pockets 42 and small ‘U’-shaped pockets 44 are smaller than the diameter buffer tube 12. This also creates a high-friction interference which provides a degree of support and strain relief. Rectangular pockets 46 are much wider than the diameter of a large buffer tube 12 and are horizontally aligned with the small ‘U’-shaped pockets 44 of an adjacent slot 140. When buffer tube 12 has a large diameter, the interference fit between small ‘U’-shaped pockets 44 may be excessive, so rectangular pockets 46 provide a cavity into which the elastomeric material of tube holder 126 can deform to prevent damage to the buffer tubes.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A fiber optic splice tray with a splice support system comprising:
a splice tray; and
a splice support system wherein the splice support system includes a buffer tube lock with a tube holder attached to the tray base and wherein the tube lock further includes a latch attached via a hinge to the tube holder.

2. The fiber optic splice tray with a splice support system of claim 1, further comprising a pad secured to the latch.

3. A fiber optic splice tray with a splice support system comprising:
a splice tray; and
a splice support system where the splice support system, includes a tube holder wherein the tube holder has a plurality of slots and each slot of the plurality of slots contains at least one large U-shaped portion, at least one small U-shaped portion, and at least one rectangular pocket.

4. A fiber optic splice tray with a splice support system comprising:
a splice tray; and
a splice support system where the splice support system, includes a tube holder wherein the tube holder has a plurality of slots and each slot of the plurality of slots contains one U-shaped portion.
